(19) United States
(12) Patent Application Publication
(10) Pub. No.: US 2003/0218289 A1
(43) Pub. Date: Nov. 27, 2003

(54) Bar clamping system

(75) Inventor: James Hermann, Raleigh, NC (US)

Correspondence Address: Mark D. Passler, Akerman, Senterfitt & Eidson, P.A., P.O. Box 3188, West Palm Beach, FL, 33402-3188, US

(73) Assignee: Andrews Toolworks, Inc., Raleigh, NC

(21) Appl. No.: 10/152,696

(22) Filed: May 22, 2002

(51) Int. Cl. B25B 1/02

(52) U.S. Cl. 269/204

(57) ABSTRACT

A pressure pad for use with a clamp in which the clamp has a clamping section that contacts the pressure pad. The pressure pad includes a first segment, at least one second segment attached to and extending away from the first segment and at least one third segment attached to and extending away from the second segment in a direction generally parallel to the first segment in which the first, second and third segments form a passage that enables the pressure pad to selectively slidably engage a clamping section.

### CROSS-REFERENCE TO RELATED APPLICATIONS

(Not Applicable)

### STATEMENT REGARDING FEDERALLY SPONSORED RESEARCH OR DEVELOPMENT

(Not Applicable)

### BACKGROUND

1. Technical Field

The present invention relates generally to workstand equipment, and more particularly to adjustable clamps for supporting workpieces.

2. Description of Related Art

Currently, many craftsmen use clamping devices to support or hold in place a wide variety of workpieces such as blocks of wood or sections of pipe. As an example, many workers use vices or other clamping assemblies for adjustably securing workpieces. Typically, such devices include two cooperating clamps in which a portion of each clamp contains a relatively flat surface for engaging a suitable section of the workpiece. One of the clamps is normally permanently attached to or otherwise immobilized relative to a surface such as a table or a beam; the other clamp is movable or adjustable and is either slidably engaged to the surface or mounted on a section of the device that enables the movable clamp to move closer to or farther away from the secured clamp. The movable clamp usually contains structure for enabling a user to force the movable clamp towards or away from the secured clamp.

Although useful for securing workpieces, such clamping devices may damage the workpiece, particularly if the workpiece is constructed of a relatively inflexible material. As an example, many of the flat surfaces included with the clamps contain ridges or other surface variations to improve the grip provided by the clamps. These gripping surfaces can cause corresponding surface damage on a workpiece held in place by the clamps. Moreover, even those clamps that do not include ridges and have a relatively smooth gripping surface can still deform a workpiece if the clamps are too tight. Thus, what is needed is a way to protect workpieces help in place by a clamping device without significantly increasing costs or design complexity or interfering with work efficiency.

### BRIEF DESCRIPTION OF THE DRAWINGS

FIG. 1 is a perspective view of a clamping system containing pressure pads in accordance with the inventive arrangements.

FIG. 2 is a perspective view of a pressure pad in accordance with the inventive arrangements.

FIG. 3 is a partial perspective view of an alternative clamping system in accordance with the inventive arrangements.

### SUMMARY OF THE INVENTION

The present invention concerns a pressure pad for use with a clamp in which the clamp has a clamping section that contacts the pressure pad. The pressure pad includes a first segment, at least one second segment attached to and extending away from the first segment and at least one third segment attached to and extending away from the second segment in a direction generally parallel to the first segment. The first, second and third segments form a passage that enables the pressure pad to selectively slidably engage the clamping section. In one arrangement, the passage can have a width that is a predetermined distance, and the predetermined distance can be wide enough to enable the pressure pad to slidably engage the clamping section when a moving force is applied to the pressure pad yet narrow enough to enable the pressure pad to frictionally engage the clamping section in any one of a plurality of locations along the clamping section when the moving force is removed.

The pressure pad can include at least two second segments. The two second segments can be spaced a predetermined distance apart such that the predetermined distance can be long enough to enable the pressure pad to slidably engage the clamping section when a moving force is applied to the pressure pad yet short enough to enable the pressure pad to frictionally engage the clamping section in any one of a plurality of locations along the clamping section when the moving force is removed.

In another aspect, the first segment can include an irregular surface for improved gripping of a workpiece. The first segment can have an outside surface, and the outside surface can include the irregular surface. The pressure pad can also include at least one aperture for receiving a set fastener in which the set fastener can be used to detachably couple the pressure pad to the clamping section. The aperture can be disposed on the second segment or the third segment.

In another arrangement, the pressure pad can include a plurality of serrations for engaging a plurality of corresponding serrations disposed on the clamping section. The third segment can have an inner surface, and the pressure pad serrations can be disposed on the inner surface of the third segment. Alternatively the first segment can have an inner surface, and the pressure pad serrations can be disposed on the inner surface of the first segment. In another aspect of the invention, the first, second and third segments can be constructed of a flexible material. As an example, the flexible material can be rubber or plastic.

The present invention also concerns a clamping system. The clamping system includes at least one of a screw press and a spring foot having at least one clamping surface and at least one pressure pad. The pressure pad includes a first segment, at least one second segment attached to and extending away from the first segment and at least one third segment attached to and extending away from the second segment in a direction generally parallel to the first segment. The first, second and third segments form a passage that enables the pressure pad to selectively slidably engage the clamping section of at least one of the screw press and the spring foot.

In one arrangement, the passage can have a width that is a predetermined distance, and the predetermined distance can be wide enough to enable the pressure pad to slidably engage the clamping section when a moving force is applied to the pressure pad yet narrow enough to enable the pressure pad to frictionally engage the clamping section in any one of a plurality of locations along said clamping section when the moving force is removed. In this arrangement, the first segment can also include an irregular surface for improved gripping of a workpiece.

The pressure pad of the clamping system can include at least two second segments. The two second segments can be spaced a predetermined distance apart such that the predetermined distance can be long enough to enable the pressure pad to slidably engage the clamping section when a moving force is applied to the pressure pad; conversely, the predetermined distance can be short enough to enable the pressure pad to frictionally engage the clamping section in any one of a plurality of locations along the clamping section when the moving force is removed.

The pressure pad can also include at least one aperture for receiving a set fastener in which the set fastener can be used to detachably couple the pressure pad to the clamping section. In another arrangement, the pressure pad can include a set of serrations, and the clamping section can include a set of serrations corresponding to the pressure pad serrations. The pressure pad serrations and the clamping section serrations can engage each other to prevent the pressure pad from slipping as the pressure pad engages a workpiece. In addition, the pressure pad serrations and the clamping section serrations can incrementally and continuously disengage one another when a moving force is applied to the pressure pad to permit movement of the pressure pad when the pressure pad disengages the workpiece. Also in this arrangement, the first, second and third segments can be constructed of a flexible material.

In another aspect, the clamping system can include an elongated object for supporting at least one of the screw press and the spring foot in which the screw press can include an aperture for receiving therethrough the elongated object and further includes structure for urging the screw press along the elongated object. The spring foot can contain an aperture for receiving therethrough the elongated object and can further include structure for securing the spring foot to the elongated object.

### DETAILED DESCRIPTION OF THE PREFERRED EMBODIMENTS

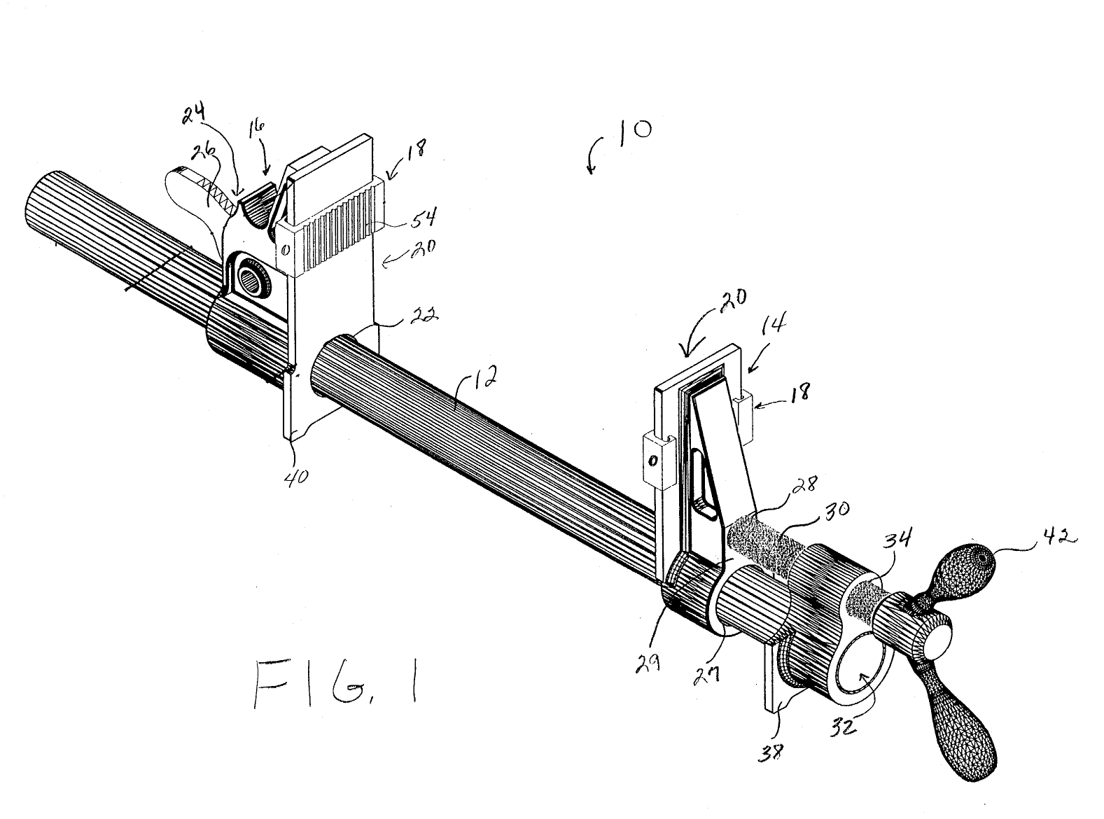

FIG. 1 illustrates a clamping system 10 according to the invention. The clamping system 10 can include an elongated object 12, a screw press 14, a spring foot 16 and one or more pressure pads 18. The screw press 14 and the spring foot 16 can include a clamping section 20. The clamping section 20 can be a substantially flat component for engaging a workpiece (not shown) such as a block of wood or a pipe. As will be explained later, the pressure pad 18 can selectively slidably engage the clamping section 20 of either the screw press 14 or the spring foot 16. Although FIG. 1 illustrates only one pressure pad 18 engaged to the clamping section 20 of the screw press 14 and the spring foot 16, it is understood that any suitable number of pressure pads 18 can be used with the invention.

The spring foot 18 can include an aperture 22 for receiving therethrough the elongated object 12. The spring foot 18 can also include a locking mechanism 24 for securing the spring foot 18 to the elongated object 12. In one arrangement, the locking mechanism 24 can include a releasable latch 26 that can engage the elongated object 12 when placed in a locking position (as shown) and can disengage the elongated object 12 when adjusted to an unlocking position. It must be noted that the invention is not limited to the locking mechanism 24, as any other suitable structure can be used to detachably secure the spring foot 16 to the elongated object 12.

The screw press 14 can include an aperture 27 for receiving therethrough the elongated object 12 and a chamber 28 for receiving another elongated object 30. In another arrangement, instead of having the chamber 28, the screw press 14 can have a flat surface 29 for receiving the elongated object 12. The clamping system 10 can also include a thread foot 32. The thread foot 32 can include an aperture 34 for receiving therethrough the elongated object 30. In addition, the thread foot 32 can include a chamber (not shown) for receiving one end of the elongated object 12 and a base 38 to help stabilize the clamping system 10. In one arrangement, the clamping section 20 of the spring foot 16 can include a base 40 to complement the base 38 to increase the stability of the clamping system 10. Placing the base 38 on the thread foot 32 can enable the screw press 14 to be moved relatively freely along the elongated object 12.

A handle 42 can be attached to the elongated object 30. In one arrangement, the elongated object 30 can be threaded, and the aperture 34 can include an inside surface (not shown) having cooperating threads (not shown) for engaging the threads of the elongated object 30. In operation, as the handle 42 is turned in a clockwise direction, the elongated object 30 can move through the aperture 34 of the thread foot 32 and can apply a force to the screw press 14 through the chamber 28 or flat surface 29. This force can urge the screw press 14 along the elongated object 12 towards the spring foot 16.

Conversely, the handle 42 can be turned in a counter clockwise direction, and the elongated object 30 can move through the thread foot 32 in a direction away from the screw press 14. The screw press 14 can then be moved along the elongated object 12 in a direction away from the spring foot 16. Moreover, those of ordinary skill in the art will appreciate that the elongated object 30 can be coupled to the screw press 14 in such a way as to permit the elongated object 30 to remain engaged to the screw press 14 as the handle 42 is turned in a counter clockwise direction. Thus, the thread foot 32, the elongated object 30 and the handle 42 can serve to urge the screw press 14 along the elongated object 12 to allow the screw press 14 and the spring foot 16 to secure a workpiece. It is understood, however, that the invention is not limited in this regard, as any other suitable structure can be used to move the screw press 14 along the elongated object 12.

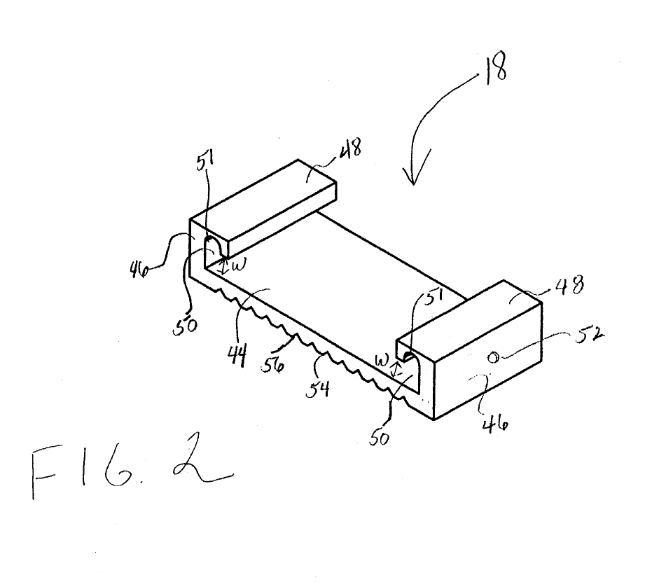

FIG. 2 illustrates a perspective view of the pressure pad 18. The following discussion applies to both FIGS. 1 and 2. The pressure pad 18 can include a first segment 44, at least one second segment 46 attached to and extending away from the first segment 44 and at least one third segment 48 attached to and extending away from the second segment 46. The first segment 44, the second segment 46 and the third segment 48 can form a passage 50 that can enable the pressure pad 18 to selectively slidably engage the clamping section 20 of either the screw press 14 or the spring foot 16.

The first segment 44, the second segment 46 and the third segment 48 can be constructed of a flexible material such as rubber or plastic. Of course, the invention is not limited in this regard, as the segments 44, 46 and 48 can be constructed of any other material suitable for engaging a workpiece.

In one arrangement, the passage 50 can have a width W that is a predetermined distance, and the predetermined distance can be wide enough to enable the pressure pad 18 to slidably engage the clamping section 20 of the screw press 14 or the spring foot 16 when a moving force is applied to the pressure pad 18; however, the predetermined distance can be narrow enough to enable the pressure pad 18 to frictionally engage the clamping section 20 of the screw press 14 or the spring foot 16 in any one of a plurality of locations along the clamping section 20 when the moving force is removed.

For example, a user can grasp the pressure pad 18 and can slide the pressure pad 18 in a substantially vertical direction along the clamping section 20 of the screw press 14 or the spring foot 16 to any desired location on the clamping section 20. The term “substantially vertical” can mean true vertical in addition to slight or even moderate deviations therefrom. Once suitably positioned, the user can release the pressure pad 18, and the pressure pad 18 can frictionally engage the clamping section 20 to remain at the selected location.

Similarly, if the pressure pad 18 has at least two second segments 46, the second segments 46 can be spaced apart by a predetermined distance such that the predetermined distance can be long enough to permit the pressure pad 18 to slidably engage the clamping section. 20 when a moving force is applied to the pressure pad 18. Additionally, the predetermined distance is short enough to enable the pressure pad 18 to frictionally engage the clamping section 20 in any one of a plurality of locations along the clamping section 20 when the moving force is removed. Thus, the predetermined distance of the passage 50 and the predetermined distance between the second segments 46 can, in combination, permit the selective slidable engagement of the pressure pad 18 to the clamping section 20. In addition, either of these arrangements can be used solely to permit this type of engagement. Accordingly, the pressure pad 18 can be constructed to selectively slidably engage a wide variety of clamping sections 20.

The third segment 48 can also contain a substantially semicircular notch 51. It is understood that the term “substantially semicircular” can mean true semicircular in addition to slight or even moderate deviations therefrom. The semicircular notch 51 can reduce the portion of the third segment 48 in contact with the clamping section 20 thereby making it easier to slide the pressure pad 18 along the clamping section 20. Such an arrangement, however, does not interfere with the frictional engagement between the pressure pad 18 and the clamping section 20 once the pressure pad 18 is positioned at a selected location along the clamping section 20. Those of ordinary skill in the art will appreciate that the invention is in no way limited to this particular embodiment, as the third segment 48 can include any other suitable configuration for engaging the clamping section 20.

Referring to FIGS. 1 and 2, in another arrangement, the pressure pad 18 can include one or more apertures 52 for receiving a set fastener (not shown). The set fastener can be used to detachably couple the pressure pad 18 to the clamping section 20 of the screw press 14 or the spring foot 16. The set fastener can be used solely to secure the pressure pad 18 to the clamping section; it can also be used as a complement to the arrangement discussed above in which setting or regulating the predetermined distance of the passage 50 or the predetermined distance between the second segments 46 is used for purposes of securing the pressure pad 18 to the clamping section 20. The set fastener can be any fastener suitable for securing the pressure pad 18 to the clamping section 20 such as a set screw. The apertures 52 can be disposed at any suitable location on the pressure pad 18 including the second segment 46 or the third segment 48.

As also shown in FIGS. 1 and 2, the pressure pad 18 can include an irregular surface 54 for improved gripping of a workpiece. As an example, the irregular surface 54 of the pressure pad 18 can include a plurality of substantially vertical ridges, which can help prevent the pressure pad 18 from slipping when it is in contact with the workpiece. The invention, however, is not limited to this particular example. In fact, the irregular surface 54 can be any pattern that deviates from a substantially flat surface that can help prevent the pressure pad 18 from slipping. It should also be noted that the term “substantially vertical” can include true vertical as well as slight or even moderate deviations therefrom. Likewise, “substantially flat” can include completely flat surfaces in addition to slight or even moderate deviations therefrom.

Referring to FIG. 2, the first segment 44 can have an outside surface 56. In one embodiment, the outside surface 56 of the pressure pad 18 can include the irregular surface 54. Nevertheless, it is understood that the irregular surface 54 can disposed on any other suitable location of the pressure pad 18.

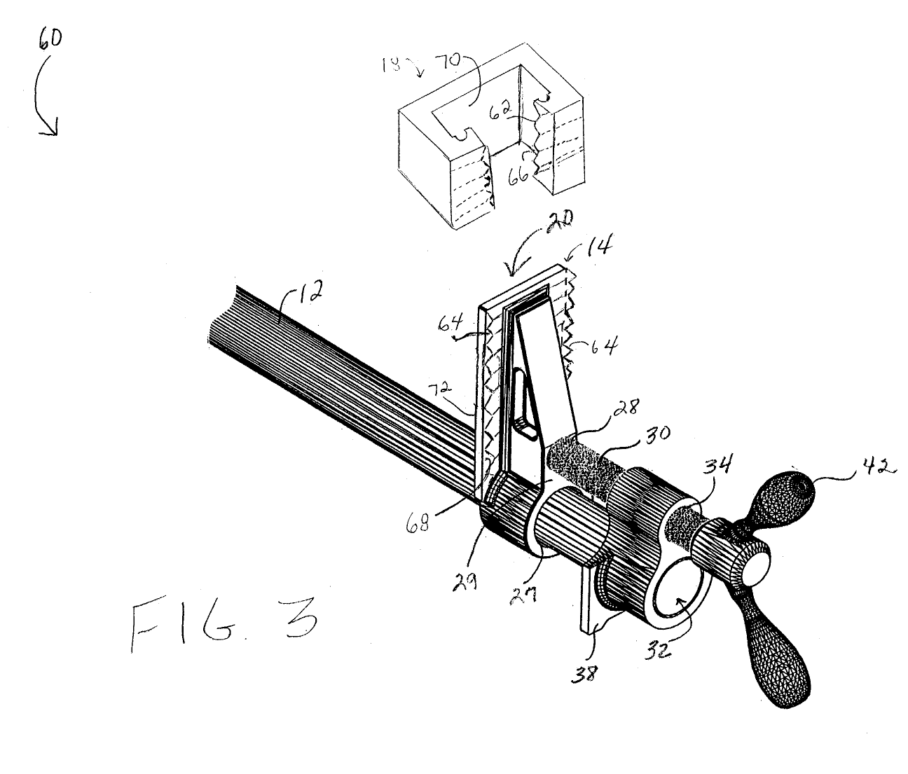

Referring to FIG. 3, a partial perspective view of an alternative clamping system 60 is shown. Similar to the clamping system 10, the clamping system 60 can include an elongated bar 12, a screw press 14 having a clamping section 20, one or more pressure pads 18, a thread foot 32, an elongated object 30 and a handle 42. Although not pictured, the clamping system 60 can also include a spring foot 16 and its associated components.

The pressure pad 18 can include a set of serrations 62, and the clamping section 20 of the screw press 14 or the spring foot 16 can include a set of serrations 64 corresponding to the pressure pad serrations 62. The serrations 62 of the pressure pad 18 can engage the serrations 64 of the clamping section 20 to prevent the pressure pad 18 from slipping as it contacts or engages a workpiece. In contrast, once the pressure pad 18 disengages the workpiece, the serrations 62 and the serrations 64 can incrementally and discontinuously disengage one another to permit the pressure pad 18 to be positioned at a suitable location when a moving force is applied to the pressure pad 18.

The serrations 62 of the pressure pad 18 and the serrations 64 of the clamping section 20 can be constructed of any material suitable for facilitating their engagement or disengagement. Examples include plastic, rubber or metal. In addition, the serrations 62 and the serrations 64 can be permanently attached to the pressure pad 18 and clamping section 20 respectively; alternatively, the serrations 62 and the serrations 64 can be detachably coupled to the pressure pad 18 and the clamping section 20 respectively through the use of, for example, a set fastener.

Although FIG. 3 shows the serrations 62 disposed on an inside surface 66 of the third segment 48 and the serrations 64 on an outside surface 68 of the clamping section 20, the invention is not limited to this particular arrangement. As an example, the serrations 62 can be disposed on an inside surface 70 of the first segment 44, and the serrations 64 can be disposed on an inside surface 72 of the clamping section 20. Nonetheless, the serrations 62 and the serrations 64 can be disposed at any suitable location on the pressure pad 18 and the clamping section 20 respectively so long as the serrations 62 and the serrations 64 can engage or disengage one another.

While preferred embodiments of the invention have been illustrated and described, it will be clear the invention is not so limited. Numerous modifications, 20 changes, substitutions and equivalents will occur to those skilled in the art without departing from the spirit and scope of the invention as described in the claims.

What is claimed is:

1. A pressure pad for use with a clamp, wherein the clamp has a clamping section that contacts said pressure pad, said pressure pad comprising:
a first segment;
at least one second segment attached to and extending away from said first segment; and
at least one third segment attached to and extending away from said second segment in a direction generally parallel to said first segment;
wherein said first, second and third segments form a passage that enables said pressure pad to selectively slidably engage the clamping section.

2. The pressure pad according to claim 1, wherein said passage has a width that is a predetermined distance and said predetermined distance is wide enough to enable said pressure pad to slidably engage the clamping section when a moving force is applied to said pressure pad yet narrow enough to enable said pressure pad to frictionally engage the clamping section in any one of a plurality of locations along the clamping section when said moving force is removed.

3. The pressure pad according to claim 1, wherein said pressure pad includes at least two said second segments;
wherein said two second segments are spaced a predetermined distance apart such that said predetermined distance is long enough to enable said pressure pad to slidably engage the clamping section when a moving force is applied to said pressure pad yet short enough to enable said pressure pad to frictionally engage the clamping section in any one of a plurality of locations along the clamping section when said moving force is removed.

4. The pressure pad according to claim 1, wherein said first segment includes an irregular surface for improved gripping of a workpiece.

5. The pressure pad according to claim 4, wherein said first segment has an outside surface and said outside surface includes said irregular surface.

6. The pressure pad according to claim 1, wherein said pressure pad includes at least one aperture for receiving a set fastener;
wherein the set fastener is used to detachably couple said pressure pad to the clamping section.

7. The pressure pad according to claim 6, wherein said aperture is disposed on said second segment.

8. The pressure pad according to claim 6, wherein said aperture is disposed on said third segment.

9. The pressure pad according to claim 1, wherein said pressure pad includes a plurality of serrations for engaging a plurality of corresponding serrations disposed on the clamping section.

10. The pressure pad according to claim 9, wherein said third segment has an inner surface and said pressure pad serrations are disposed on said inner surface of said third segment.

11. The pressure pad according to claim 9, wherein said first segment has an inner surface and said pressure pad serrations are disposed on said inner surface of said first segment.

12. The pressure pad according to claim 1, wherein said first, second and third segments are constructed of a flexible material.

13. The pressure pad according to claim 12, wherein said flexible material is a material selected from the group comprising rubber or plastic.

14. A clamping system, comprising:
at least one of a screw press and a spring foot having at least one clamping surface; and
at least one pressure pad;
wherein said pressure pad comprises:
a first segment;
at least one second segment attached to and extending away from said first segment; and
at least one third segment attached to and extending away from said second segment in a direction generally parallel to said first segment;
wherein said first, second and third segments form a passage that enables said pressure pad to selectively slidably engage said clamping section of at least one of said screw press and said spring foot.

15. The clamping system according to claim 14, wherein said passage has a width that is a predetermined distance and said predetermined distance is wide enough to enable said pressure pad to slidably engage said clamping section when a moving force is applied to said pressure pad yet narrow enough to enable said pressure pad to frictionally engage said clamping section in any one of a plurality of locations along said clamping section when said moving force is removed.

16. The clamping system according to claim 14, wherein said pressure pad includes at least two said second segments;
wherein said two second segments are spaced a predetermined distance apart such that said predetermined distance is long enough to enable said pressure pad to slidably engage said clamping section when a moving force is applied to said pressure pad yet short enough to enable said pressure pad to frictionally engage said clamping section in any one of a plurality of locations along said clamping section when said moving force is removed.

17. The clamping system according to claim 14, wherein said first segment includes an irregular surface for improved gripping of a workpiece.

18. The clamping system according to claim 14, wherein said pressure pad includes at least one aperture for receiving a set fastener;
wherein the set fastener is used to detachably couple said pressure pad to said clamping section.

19. The clamping system according to claim 14, wherein said pressure pad includes a set of serrations and said clamping section includes a set of serrations corresponding to said pressure pad serrations;
wherein said pressure pad serrations and said clamping section serrations engage each other to prevent said pressure pad from slipping as said pressure pad engages a workpiece;
wherein said pressure pad serrations and said clamping section serrations incrementally and continuously disengage one another when a moving force is applied to said pressure pad to permit movement of said pressure pad when said pressure pad disengages the workpiece.

20. The clamping system according to claim 14, wherein said first, second and third segments are constructed of a flexible material.

21. The clamping system according to claim 14, further comprising an elongated object for supporting at least one of said screw press and said spring foot;
wherein said screw press includes an aperture for receiving therethrough said elongated object and further comprises structure for urging said screw press along said elongated object.

22. The clamping system according to claim 21, wherein said spring foot contains an aperture for receiving therethrough said elongated object and further comprises structure for securing said spring foot to said elongated object.
